(19) United States
(12) Patent Application Publication
(10) Pub. No.: US 2013/0325395 A1
(43) Pub. Date: Dec. 5, 2013

(54) CO-OPTIMIZATION OF SCATTEROMETRY MARK DESIGN AND PROCESS MONITOR MARK DESIGN

(71) Applicants: Wenzhan Zhou, Singapore (SG); Moshe Preil, Sunnyvale, CA (US); Zheng Zou, Singapore (SG)

(72) Inventors: Wenzhan Zhou, Singapore (SG); Moshe Preil, Sunnyvale, CA (US); Zheng Zou, Singapore (SG)

(73) Assignee: GLOBALFOUNDRIES Singapore Pte. Ltd., Singapore (SG)

(21) Appl. No.: 13/486,262

(22) Filed: Jun. 1, 2012

(51) Int. Cl. G01B 11/02; G06F 15/00

(52) U.S. Cl. 702/155; 356/625

(57) ABSTRACT

An automated method for co-optimizing a scatterometry mark and a process monitoring mark is provided. Embodiments include generating a series of pattern profiles on a photoresist on a wafer; providing the series of pattern profiles, resist process parameters, and scatterometry critical dimension parameters as inputs for a scatterometry measurement; performing scatterometry measurement to generate spectra from the series of pattern profiles; and optimizing a sensitivity precision correlation for the resist process parameter.

### TECHNICAL FIELD

The present disclosure relates to optimization of scatterometry mark design and process monitoring mark design during semiconductor fabrication. The present disclosure is particularly applicable to EUV scanner focus monitoring, particularly for semiconductor devices in 45 nanometer (nm) technology nodes and beyond.

### BACKGROUND

As critical dimensions (CDs) for semiconductors shrink to 32 nm and beyond, process control and equipment control become increasingly important. To increase the CD measurement accuracy and sensitivity, scatterometry is widely used for inline pattern profile monitoring. Since optical limitations of scatterometry restrict the types of marks that are suitable for scatterometry measurement, optimization is needed for scatterometry mark design. Currently, scatterometry is mainly used as a CD and profile measurement tool, so the software optimization engine is designed to optimize the sensitivity, precision, and correlation for CD, sidewall angle and height, etc. However, optimization types that are good for scatterometry measurement (for example, dense line) may not provide a scatterometry mark which is sufficiently sensitive for monitoring process parameters, such as focus. For example, whereas a dense pattern is good for scatterometry measurement, an isolated pattern is good for focus measurement. Currently, the optimization of scatterometry marks and process monitoring marks are done in separate optimization loops, at least in part due to the different requirements for each. Accordingly, the two optimization requirements must be manually optimized and balanced by engineering experience.

A need therefore exists for methodology enabling automated design of a mark which can balance performance scatterometry and process monitoring.

### SUMMARY

An aspect of the present disclosure is a method of optimizing a sensitivity parameter for a resist process parameter by using resist process parameters as inputs for a scatterometry measurement.

Another aspect of the present disclosure is an apparatus configured to optimize a sensitivity parameter for a resist process parameter by using resist process parameters as inputs for a scatterometry measurement.

Additional aspects and other features of the present disclosure will be set forth in the description which follows and in part will be apparent to those having ordinary skill in the art upon examination of the following or may be learned from the practice of the present disclosure. The advantages of the present disclosure may be realized and obtained as particularly pointed out in the appended claims.

According to the present disclosure, some technical effects may be achieved in part by a method including generating a series of pattern profiles on a photoresist on a wafer; providing the series of pattern profiles, resist process parameters, and scatterometry critical dimension parameters as inputs for a scatterometry measurement; performing scatterometry measurement to generate spectra from the series of pattern profiles; and optimizing a sensitivity precision correlation for the resist process parameter.

Aspects include providing pitch and photoresist thickness as inputs for the scatterometry measurement. Further aspects include the resist process parameter being focus. Other aspects include optimizing by evaluating the spectra and finding a test pattern that yields the most sensitive spectrum result. Additional aspects include optimizing by evaluating the spectra and determining the type of mark that gives good spectrum response. Further aspects include generating the series of pattern profiles by: illuminating the wafer with a plurality of wavelengths; measuring scattered light; and generating the patterned profiles based on the measured scattered light.

Another aspect of the present disclosure is a method including: simulating a series of pattern profiles on a photoresist on a wafer; providing the series of pattern profiles, resist process parameters, and scatterometry critical dimension parameters as inputs for a scatterometry measurement; performing scatterometry measurement to generate spectra from the series of pattern profiles; and optimizing a sensitivity precision correlation for the resist process parameter.

Aspects of the present disclosure include providing pitch and photoresist thickness as inputs for the scatterometry measurement. Further aspects include the resist process parameter being focus. Other aspects include optimizing by evaluating the spectra and finding a test pattern that yields the most sensitive spectrum result. Another aspect includes optimizing by evaluating the spectra and determining the type of mark that gives good spectrum response. Additional aspects include generating the series of pattern profiles by: simulating illuminating the wafer with a plurality of wavelengths; measuring scattered light; and generating the patterned profiles based on the measured scattered light.

Another aspect of the present disclosure is an apparatus comprising: a processor; and a memory including computer program code for one or more programs, the memory and the computer program code configured to, with the processor, cause the apparatus to perform at least the following: generating a series of pattern profiles for a wafer providing the series of pattern profiles, resist process parameters, and scatterometry critical dimension parameters as inputs for a scatterometry measurement; performing scatterometry measurement to generate spectra from the series of pattern profiles; and optimizing a sensitivity precision correlation for the resist process parameter.

Aspects of the present disclosure include an including a memory and computer program code configured to, with the processor, further cause the apparatus to provide pitch and photoresist thickness as inputs for the scatterometry measurement. Aspects further include an apparatus an apparatus wherein the resist parameter is focus. Other aspects include an apparatus including a memory and computer program code configured to, with the processor, cause the apparatus to optimize by evaluating the spectra and finding a test pattern that yields the most sensitive spectrum result. Another aspects includes an apparatus including a memory and computer program code configured to, with the processor, cause the apparatus to optimize by evaluating the spectra and determining the type of mark that gives good spectrum response. Additional aspects include an apparatus including a memory and computer program code configured to, with the processor, cause the apparatus to generate the series of pattern profiles by: simulating illuminating the wafer with a plurality of wavelengths; measuring scattered light; and generating the patterned profiles based on the measured scattered light.

Additional aspects and technical effects of the present disclosure will become readily apparent to those skilled in the art from the following detailed description wherein embodiments of the present disclosure are described simply by way of illustration of the best mode contemplated to carry out the present disclosure. As will be realized, the present disclosure is capable of other and different embodiments, and its several details are capable of modifications in various obvious respects, all without departing from the present disclosure. Accordingly, the drawings and description are to be regarded as illustrative in nature, and not as restrictive.

### BRIEF DESCRIPTION OF THE DRAWINGS

The present disclosure is illustrated by way of example, and not by way of limitation, in the figures of the accompanying drawing and in which like reference numerals refer to similar elements and in which:

FIG. 1 illustrates focus sensitivity optimization for focus monitoring;

FIG. 2 illustrates scatterometry mark optimization for scatterometry measurements; and

FIG. 3. illustrates a single loop optimization combining focus sensitivity optimization and scatterometry mark optimization, in accordance with an exemplary embodiment.

### DETAILED DESCRIPTION

In the following description, for the purposes of explanation, numerous specific details are set forth in order to provide a thorough understanding of exemplary embodiments. It should be apparent, however, that exemplary embodiments may be practiced without these specific details or with an equivalent arrangement. In other instances, well-known structures and devices are shown in block diagram form in order to avoid unnecessarily obscuring exemplary embodiments. In addition, unless otherwise indicated, all numbers expressing quantities, ratios, and numerical properties of ingredients, reaction conditions, and so forth used in the specification and claims are to be understood as being modified in all instances by the term “about.”

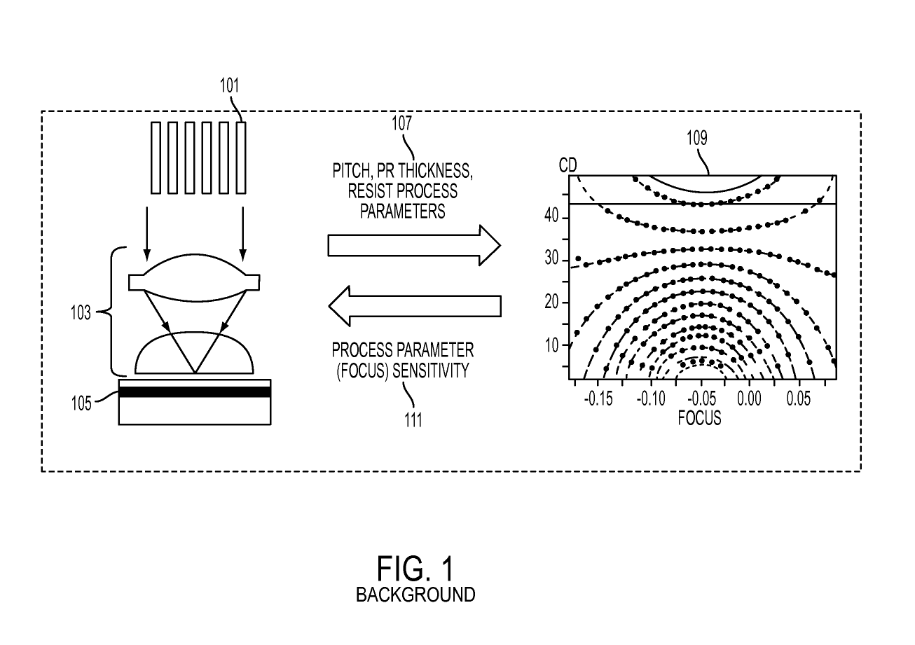

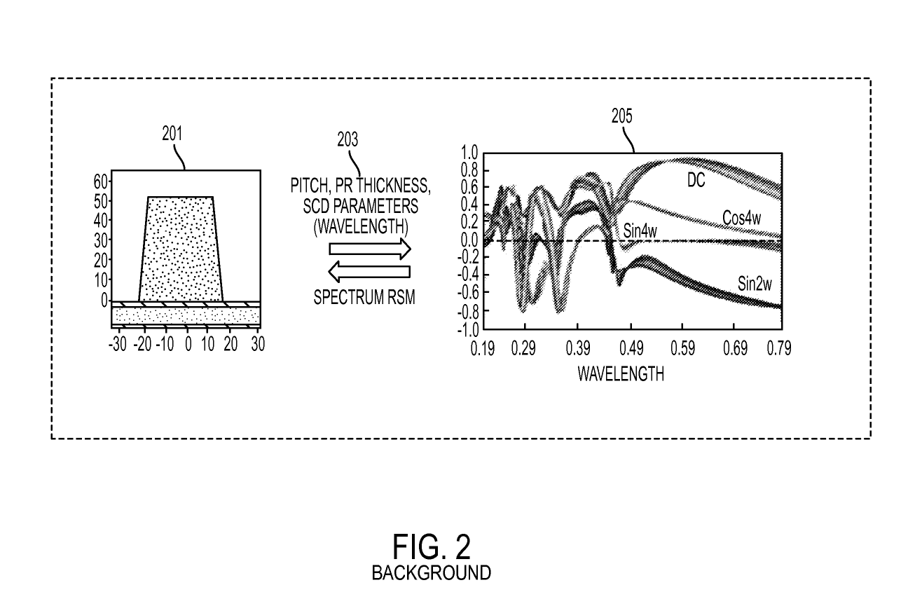

FIG. 1 illustrates focus monitoring for focus sensitivity optimization. As shown, light is directed through a focus pattern 101, and focused through optics 103, e.g. lenses, onto a wafer surface 105. Pitch, photoresist thickness, and resist process parameters 107 are input, focus versus critical dimension is plotted (shown at 109), and process parameter (focus) sensitivity 111 is determined. Any pattern, dense, semidense, or iso pattern, may be utilized for focus monitoring. However, during focus monitoring optimization, isolated features give better focus sensitivity than dense features (where dense is defined as the minimum spacing). FIG. 2 illustrates scatterometry mark optimization for scatterometry measurement. As shown, a simulated pattern profile, e.g. a resist profile 201 is illustrated. X is the dimension parallel with the wafer surface, and y is the dimension perpendicular to the wafer surface. Pitch, photoresist thickness, and spectroscopic critical dimension (SCD) parameters 203 are input for a scatterometric process. The wafer is illuminated with light of a variety of wavelengths, and the scattered light is measured, shown at 205. From the results, spectrum response optimization, for example surface response methodology, is performed to find a test pattern which yields the most sensitive spectrum response. The scatterometry measurement may be performed on any type of structure, but a dense feature yields a better measurement result as compared with the isolated feature during scatterometry optimization. Thus, the two optimizations are contradictory to each other.

The present disclosure addresses and solves the current problem of manual balancing of scatterometry optimization and process monitoring optimization attendant upon CD measurements for accuracy and sensitivity. In accordance with embodiments of the present disclosure, the process parameter, for example focus, is employed as an input parameter for a scatterometry measurement. This results in an improved sensitivity of spectrum to the process parameter rather than traditional metrology results such as CD, sidewall angle, and height, among others.

Methodology in accordance with embodiments of the present disclosure includes generating a series of pattern profiles on a photoresist on a wafer, for example by illuminating the wafer with several wavelengths and measuring the scattered light, providing the series of pattern profiles, resist process parameters, and scatterometry critical dimension parameters as inputs for a scatterometry measurement, performing scatterometry measurement to generate spectra from the series of pattern profiles, and optimizing a sensitivity precision correlation for the resist process parameter.

Still other aspects, features, and technical effects will be readily apparent to those skilled in this art from the following detailed description, wherein preferred embodiments are shown and described, simply by way of illustration of the best mode contemplated. The disclosure is capable of other and different embodiments, and its several details are capable of modifications in various obvious respects. Accordingly, the drawings and description are to be regarded as illustrative in nature, and not as restrictive.

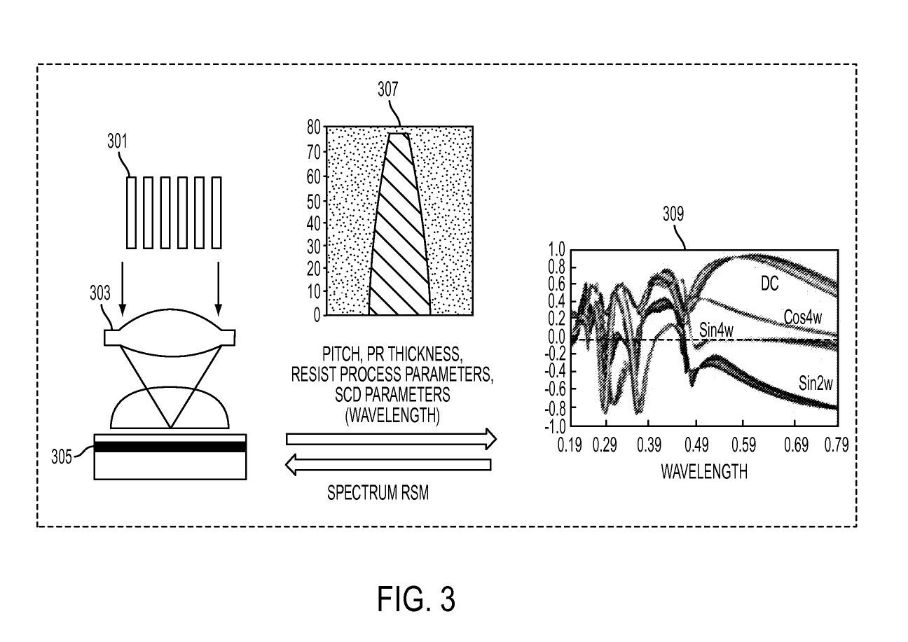

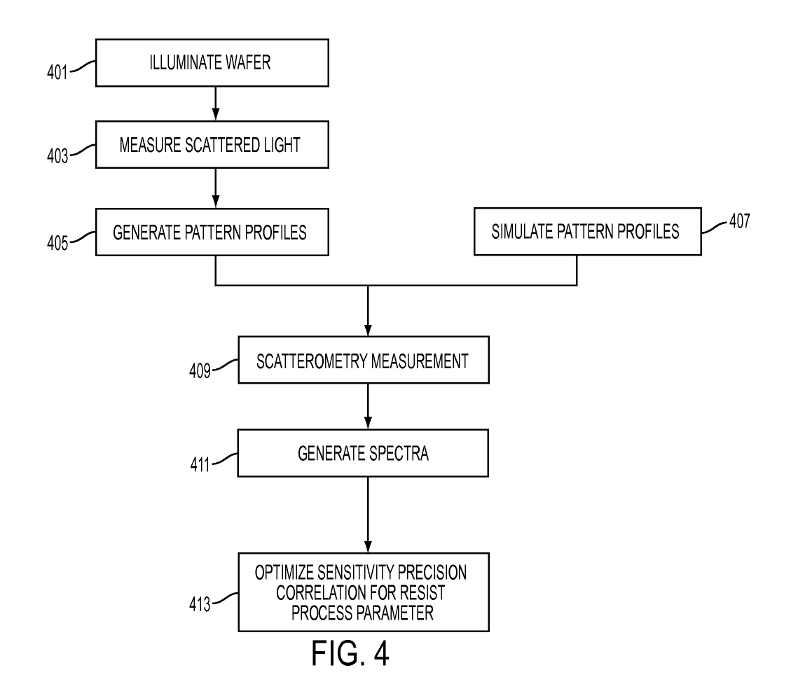

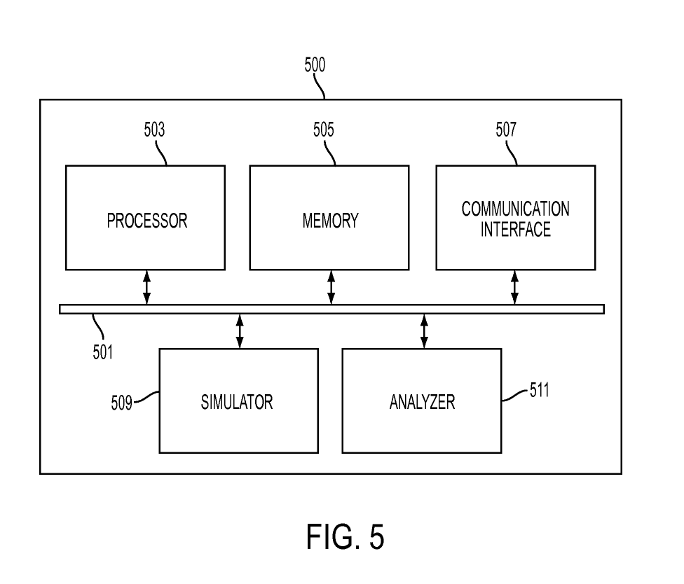

Adverting to FIGS. 3 and 4, a combined optimization loop and a process flow thereof, respectively, are illustrated in accordance with an exemplary embodiment. Similar to the focus monitoring of FIG. 1, light is directed through a focus pattern 301, and focused through optics 303, e.g. lenses, onto a wafer surface 305, for example a photoresist. However, unlike FIG. 1, light of multiple wavelengths is directed at the photoresist (step 401), scattered light is measured (step 403), and a series of pattern profiles 307 is generated at step 405. Alternatively, a series of pattern profiles may be simulated (step 407), and further steps may use the result of the simulation. The pattern profiles, pitch, photoresist thickness, and resist process parameters 107 are provided as inputs for a scatterometry measurement (step 409), and spectra 309 are generated from the series of pattern profiles (step 411). From an evaluation of the spectra, a sensitivity precision correlation for the resist process parameter (e.g., focus) may be optimized (step 413). For example, a mark that gives good spectrum response may be determined.

FIG. 5 schematically illustrates a computer system 500 upon which an exemplary embodiment of the invention may be implemented. Computer system 500 may, for instance, be programmed (e.g., via computer program code or instructions) to provide a mark that gives good spectrum response, as described herein and may include a communication mechanism such as a bus 501 for passing information between other internal and external components of the computer system 500. Moreover, computer system 500 may include a processor (or multiple processors) 503 for performing a set of operations on information as specified by computer program code related to providing a mark that gives good spectrum response. Computer system 500 may also include memory 505 coupled to bus 501. The memory 505 may, for instance, include dynamic storage, static storage, or a combination thereof for storing information including pattern profiles, pitch, photoresist thickness, and resist process parameters.

By way of example, based on computer program code in memory 505, processor 503 may interact with communication interface 507 and may then work with simulator 509 to generate a series of pattern profiles. Simulator 509 may then provide the profiles to the processor 503 to perform a scatterometry measurement. Processor 503 may thereafter generate spectra from the pattern profiles and direct analyzer 511 to process the spectra and optimize a sensitivity precision correlation for the resist process parameters.

It is noted that, in various aspects, some or all of the techniques described herein are performed by computer system 500 in response to processor 503 executing one or more sequences of one or more processor instructions contained in memory 505. Such instructions, also called computer instructions, software and program code, may be read into memory 505 from another computer-readable medium such as a storage device or a network link. Execution of the sequences of instructions contained in memory 505 causes processor 503 to perform one or more of the method steps described herein. In alternative embodiments, hardware, such as application-specific integrated circuits (ASICs), may be used in place of or in combination with software to implement the invention. Thus, embodiments of the invention are not limited to any specific combination of hardware and software, unless otherwise explicitly stated herein.

The embodiments of the present disclosure can achieve several technical effects, including automatic co-optimization of a scatterometry mark design and process monitoring mark design. The present disclosure enjoys industrial applicability in any of various industrial applications, e.g., microprocessors, smart phones, mobile phones, cellular handsets, set-top boxes, DVD recorders and players, automotive navigation, printers and peripherals, networking and telecom equipment, gaming systems, and digital cameras. The present disclosure therefore enjoys industrial applicability in any of various types of highly integrated semiconductor devices, particularly for 45 nm technologies and beyond.

In the preceding description, the present disclosure is described with reference to specifically exemplary embodiments thereof. It will, however, be evident that various modifications and changes may be made thereto without departing from the broader spirit and scope of the present disclosure, as set forth in the claims. The specification and drawings are, accordingly, to be regarded as illustrative and not as restrictive. It is understood that the present disclosure is capable of using various other combinations and embodiments and is capable of any changes or modifications within the scope of the inventive concept as expressed herein.

What is claimed is:

1. A method comprising:
generating a series of pattern profiles on a photoresist on a wafer;
providing the series of pattern profiles, resist process parameters, and scatterometry critical dimension parameters as inputs for a scatterometry measurement;
performing scatterometry measurement to generate spectra from the series of pattern profiles; and
optimizing a sensitivity precision correlation for the resist process parameter.

2. The method according to claim 1, further comprising providing pitch and photoresist thickness as inputs for the scatterometry measurement.

3. The method according to claim 2, wherein the resist process parameter is focus.

4. The method according to claim 1, comprising optimizing by evaluating the spectra and finding a test pattern that yields the most sensitive spectrum result.

5. The method according to claim 1, comprising optimizing by evaluating the spectra and determining the type of mark that gives good spectrum response.

6. The method according to claim 1, comprising generating the series of pattern profiles by:
illuminating the wafer with a plurality of wavelengths;
measuring scattered light; and
generating the patterned profiles based on the measured scattered light.

7. A method comprising:
simulating a series of pattern profiles on a photoresist on a wafer;
providing the series of pattern profiles, resist process parameters, and scatterometry critical dimension parameters as inputs for a scatterometry measurement;
performing scatterometry measurement to generate spectra from the series of pattern profiles; and
optimizing a sensitivity precision correlation for the resist process parameter.

8. The method according to claim 7, further comprising providing pitch and photoresist thickness as inputs for the scatterometry measurement.

9. The method according to claim 8, wherein the resist process parameter is focus.

10. The method according to claim 7, comprising optimizing by evaluating the spectra and finding a test pattern that yields the most sensitive spectrum result.

11. The method according to claim 7, comprising optimizing by evaluating the spectra and determining the type of mark that gives good spectrum response.

12. The method according to claim 7, comprising generating the series of pattern profiles by:
simulating illuminating the wafer with a plurality of wavelengths;
measuring scattered light; and
generating the patterned profiles based on the measured scattered light.

13. An apparatus comprising:
a processor; and
a memory including computer program code for one or more programs,
the memory and the computer program code configured to, with the processor, cause the apparatus to perform at least the following:
generating a series of pattern profiles for a wafer
providing the series of pattern profiles, resist process parameters, and scatterometry critical dimension parameters as inputs for a scatterometry measurement;
performing scatterometry measurement to generate spectra from the series of pattern profiles; and
optimizing a sensitivity precision correlation for the resist process parameter.

14. The apparatus according to claim 13, the memory and the computer program code configured to, with the processor, further cause the apparatus to provide pitch and photoresist thickness as inputs for the scatterometry measurement.

15. The apparatus according to claim 14, wherein the resist parameter is focus.

16. The apparatus according to claim 13, the memory and the computer program code configured to, with the processor, cause the apparatus to optimize by evaluating the spectra and finding a test pattern that yields the most sensitive spectrum result.

17. The apparatus according to claim 13, the memory and the computer program code configured to, with the processor, cause the apparatus to optimize by evaluating the spectra and determining the type of mark that gives good spectrum response.

18. The apparatus according to claim 13, the memory and the computer program code configured to, with the processor, cause the apparatus to generate the series of pattern profiles by:
simulating illuminating the wafer with a plurality of wavelengths;
measuring scattered light; and
generating the patterned profiles based on the measured scattered light.
